(19) United States
(12) Patent Application Publication
(10) Pub. No.: US 2004/0196185 A1
(43) Pub. Date: Oct. 7, 2004

(54) Time difference distance measuring device and method

(76) Inventor: Neil W. Eft, Alliance, OH (US)

Correspondence Address: NEIL W. EFT, 1001 W. MILTON ST., ALLIANCE, OH, 44601, US

(21) Appl. No.: 10/407,968

(22) Filed: Apr. 7, 2003

(51) Int. Cl. G01S 3/02

(52) U.S. Cl. 342/458

(57) ABSTRACT

An electromagnetic signal emitted from a first known point is received at a second known point and is retransmitted to a third unknown point. The same signal from the first known point is also received at the third unknown point. Comparison of the two signals received at the third unknown point yields the distance between the second known point and the third unknown point.

### BACKGROUND OF THE INVENTION

Currently applicable art for the determination of distance is based primarily on global positioning system technology, which relies on multiple satellites quite remote from the area of operation.

While the GPS system may be necessary for determining the coordinates of points in space, or over long distances, it is not necessary for conditions where there is line-of-sight, such as on the surface of the earth, in open space, or the ocean. The GPS system also relies on line-of-sight but requires numerous satellites to be within sight of the target for reliable determinations.

A great many applications could be considered to be regional or local, at distances less than fifty miles. Within this range electromagnetic radiation travels essentially line-of-sight, via the shortest path between points. It is therefore possible to utilize earth-based check points rather than satellites.

### SUMMARY OF THE INVENTION

This invention compares the time-of-flight of an electromagnetic signal to the time-of-flight of the same signal travelling along a controlled calibration path, both signals traveling at a known velocity relative to the speed of light. There are two types of distances involved in this invention, the physical distance between points, as in line-of-sight communication or its equivalent, and the electronic distance between points, as in a coil of wire. This invention compares the physical distance and the electronic distance between two points. When the two are equal the distance between the electromagnetic source and an unknown point can be determined.

The use of a controlled calibration line increases the accuracy into the pico-second range. This invention is applicable to any type of device capable of transmitting and receiving electromagnetic signals. It can accurately determine the relative position or absolute coordinates of a location to an accuracy equal to, or greater than, the GPS system.

### DRAWINGS

FIG. 1. Relationship of source, repeater and unknown location

FIG. 2. Synchronization of signals

### DESCRIPTION

A distance measuring device and method for determining the distance between a known location, B, and an unknown location, C, utilizing radiation such as light or other forms of electromagnetic waves emitted at a first known location A. The distance between a first location, A, and second location, B, is known. Wave energy is broadcast from the first location, A, to both locations B and C, the signal having a variable waveform which may contain an algorithm. The signal received at the second location, B, is immediately rebroadcast at the same or a different frequency or by a different method. Location C receives both signals from locations A and B, with signal A always arriving at location C ahead of signal B. Signal A is sent through a variable length calibration line whose terminal points are at locations A and C. The calibration line is lengthened or shortened until the signals received at location C from locations A and B are synchronized. The time-of-flight from B to C equals the time delay introduced at A, plus the time-of-flight from A to C, minus the known time between A and B. The time delay from B plus the time-of-flight from A to C represents the distance between B&C since the time of flight of electromagnetic waves is constant at approximately 186,000 miles per second.

What I claim as my invention is:

1. A method for determining the physical distance between second and third points of a triangular array, when the distance between the first and second points of the array is known, said method comprising:
a. Establishing the sum of the physical length of the first known side and the electronic length of the second unknown side by comparing the sum to the electronic length of a controlled calibration line representing the third side.
b. Determining the electronic length of a controlled calibration line by mechanical or electronic means.
c. Subtracting the physical length of the known first side from the electronic length of the controlled calibration line representing the third side, to obtain the physical length of the second side.

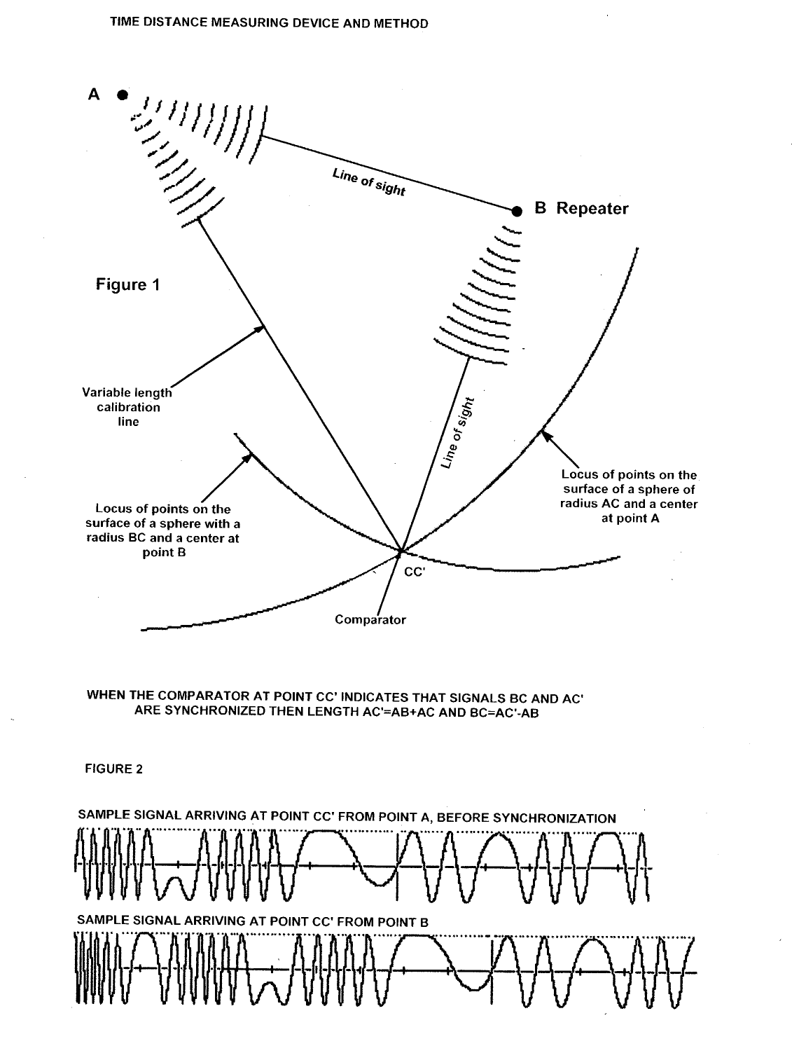

2. The method of claim 1 (FIG. 1) wherein the determination of the difference in length between two sides of the triangle as compared to the third comprises:
a. Creating an electromagnetic radiation signal at a first location
b. Receiving that electromagnetic radiation signal at a second location at a known physical distance from the first location and repeating it at a new frequency
c. Receiving both the original signal and the new signal at a third unknown location
d. Synchronizing the original signal with the new signal at the third unknown location by a variable length calibration line (FIG. 2)
e. Comparing the time of travel of the signal from the first location to the second known location plus the time of travel from the repeater to the third unknown location to an equivalent time of travel of the initial signal from the first location through a variable length calibration line to the third unknown location.

3. The method of claim 2 whereby the electromagnetic signal created at the first location contains a mathematical algorithm which permits the direct and immediate determination of the distance between two or more points.

4. The method of claim 2 where an electronic delay substitutes for a portion of the variable length calibration line such that only a short length of said line need be physically manipulated to achieve maximum accuracy.

5. The method of claim 2 whereby all, or any part of the controlled length calibration line consists of a continuous length of conductor with multiple contact points to permit access to a precise physical length of conductor.

6. The method of claim 2 whereby all, or any part of the controlled length calibration line is imprinted on or, or attached to, a rotating disk such as a compact disk or hard drive, where a precise distance can be accessed by one or more sensors.

7. The method of claim 2 where any, or all, of the electromagnetic links can be simultaneously used for carrying voice, data, music, control signals or random cyclical radiation.

8. The method of claim 2 where any, or all, of the sequential actions occur within the internal circuitry of one or more computers where the linear distance between locations is not line-of-sight.

9. The method of claim 2 where some, or all of the sequential actions occurs within the circuitry of electronic devices such as, but not limited to, cell phones, television, or radio transmitters and receivers.

10. The method of claim 2 whereby any combination of mechanical and electronic delays are selectively connected in series to provide the total time delay to synchronize the circuits.

11. The method of claim 1 whereby a system of four transmitter/receiver units locate all units relative to each other and to the plane formed by any three of the points.

12. The method of claim 1 whereby a number of repeaters, serially arranged, can extend the range of the system beyond line of sight and yield the distance between the last repeater and the unknown location.

13. The method of claim 1 whereby the initial electromagnetic signal originates at any of the repeater stations or the unknown location.

14. The method of claim 1 whereby any, or all, of the transmitters and repeaters can be in motion.

15. The method of claim 2 whereby the length of the available calibration line exceeds the line-of-sight distance between the electromagnetic source and the unknown point so that a variable length control line is inserted into the path from the source to the repeater or the repeater to the unknown point.

16. The method of claim 2 whereby two or more sources of electromagnetic radiation at different carrier frequencies transmit a recognizable algorithm, digital signals, or pulse bursts, which can be demodulated from the carrier wave and interpreted to yield the location of a third point.

17. The method of claim 2 whereby the algorithm, digital signal, or pulse burst, is periodically modified to add or delete information for security purposes.

18. The method of claim 2 whereby the electromagnetic signal received at the second location is repeated at the same frequency, either with, or without, intermediate demodulation and remodulation followed by the extraction of the significant information at the third point.
